(19) United States
(12) Patent Application Publication
(10) Pub. No.: US 2018/0374453 A1
(43) Pub. Date: Dec. 27, 2018

(54) HOLOGRAPHIC DISPLAY MIMICKING SYSTEM AND METHOD

(71) Applicant: Universal City Studios LLC, Universal City, CA (US)

(72) Inventor: Scott Stanton Verble, Orlando, FL (US)

(21) Appl. No.: 15/982,899

(22) Filed: May 17, 2018

Related U.S. Application Data
(60) Provisional application No. 62/523,534, filed on Jun. 22, 2017.

(51) Int. Cl. G09G 5/377; G09G 5/10; G09G 5/12; G09G 3/36

(52) U.S. Cl. CPC G09G 5/377; G09G 5/10; G09G 2360/04; G09G 3/36; G09G 2300/023; G09G 5/12

(57) ABSTRACT

A media display system includes a first display device configured to display a first graphic image. The media display system also includes a second display device including a transparent display configured to display a second graphic image. The first display device and the second display device are spaced apart from one another at a distance, such that the first graphic image overlaps with the second graphic image to collectively form a holographic-like presentation.

### CROSS-REFERENCE TO RELATED APPLICATION

This application claims priority to and benefit of U.S. Provisional Patent Application No. 62/523,534, entitled “HOLOGRAPHIC DISPLAY MIMICKING SYSTEM AND METHOD,” filed Jun. 22, 2017, which is herein incorporated by reference in its entirety for all purposes.

### BACKGROUND

The subject matter disclosed herein relates to amusement park attractions, and more specifically, to providing realistic and/or immersive viewing experiences in amusement park attractions.

Amusement parks or theme parks may include various entertainment attractions for providing enjoyment to guests of the amusement parks. For example, the attractions may include themed environments established using display devices displaying media content (e.g., in the form of video, text, image, motion graphics, or a combination thereof). For some applications, it may be desirable to display media content with special visual effects to create a realistic and/or immersive viewing or playing experience for an audience. In one example, such special visual effects may be achieved using holography technology, where the media content is displayed using a hologram produced by illuminating a holographic medium that encodes a light field emanating from a scene as an interference pattern. When the holographic medium is suitably lit with a light source, the interference pattern diffracts the light into a three-dimensional (3D) hologram image that exhibits visual depth cues such as parallax and perspective. However, displaying media content via a “true” holographic image (e.g., via a holographic medium that encodes a light field emanating from a scene as an interference pattern) may be challenging due to considerations relating to cost, space, equipment availabilities, viewing area environment, targeted audiences, video (moving visual image) capabilities, etc. It is now recognized that it may be desirable for an easier and/or more cost effective approach to provide realistic and immersive viewing or playing experience.

### BRIEF DESCRIPTION

Some embodiments commensurate in scope with the present disclosure are summarized below. These embodiments are not intended to limit the scope of the disclosure, but rather these embodiments are intended only to provide a brief summary of possible forms of present embodiments. Indeed, present embodiments may encompass a variety of forms that may be similar to or different from the embodiments set forth below.

In one embodiment, a media display system includes a first display device configured to display a first graphic image. The media display system also includes a second display device including a transparent display configured to display a second graphic image. The first display device and the second display device are spaced apart from one another at a distance, such that the first graphic image overlaps with the second graphic image to collectively form a holographic-like presentation.

In another embodiment, a method of forming a holographic-like presentation includes displaying a first graphic image using a first display device, such that the first graphic image appears to glow out of the first display device. The method also includes displaying a second graphic image using a second display device, wherein the second display device includes a transparent display disposed at a distance apart from the first display device, such that the first graphic image overlaps with the second graphic image and collectively form the holographic-like presentation.

In another embodiment, a media display system includes a first display device including a graphic lightbox and configured to display a first graphic image. The media display system includes a second display device including a transparent display and configured to display a second graphic image. The first display device and the second display device are spaced apart from one another at a distance, such that the first graphic image overlaps with the second graphic image to collectively form a holographic-like presentation. The media display system also includes a controller operatively coupled to the first display device and the second display device.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a dimensional display system that provides holographic-like viewing experiences to one or more audiences, in accordance with present embodiments;

FIG. 2 is a schematic diagram of a side view of an embodiment of the dimensional display system of FIG. 1, in accordance with present embodiments;

FIG. 3 is a schematic illustrating an embodiment of a holographic-like presentation provided by the dimensional display system of FIG. 1, in accordance with present embodiments; and

FIG. 4 is a flow diagram illustrating an embodiment of a process for operating the dimensional display system of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Present embodiments relate to a system and method for providing a realistic and/or immersive viewing experience. In particular, present embodiments relate to the field of displays and “false” holograms (e.g., holographic-like presentations). While a “true” holographic presentation (e.g., via a holographic medium that encodes a light field emanating from a scene as an interference pattern) may provide a realistic and/or immersive viewing experience, displaying media content via a “true” holographic image may be challenging and/or costly. As such, the present embodiments provide a dimensional display system and a method for presenting media content in the form of video, text, image, motion graphics, or a combination thereof that mimics a holographic presentation (e.g., not a “true” holographic presentation). In particular, the dimensional display system in accordance with the present embodiments renders a “holographic-like presentation” that has similar visual effects (e.g., depth effect, 3D effect) as in true holographic images, but without the challenges and/or costs associated with providing true holographic images.

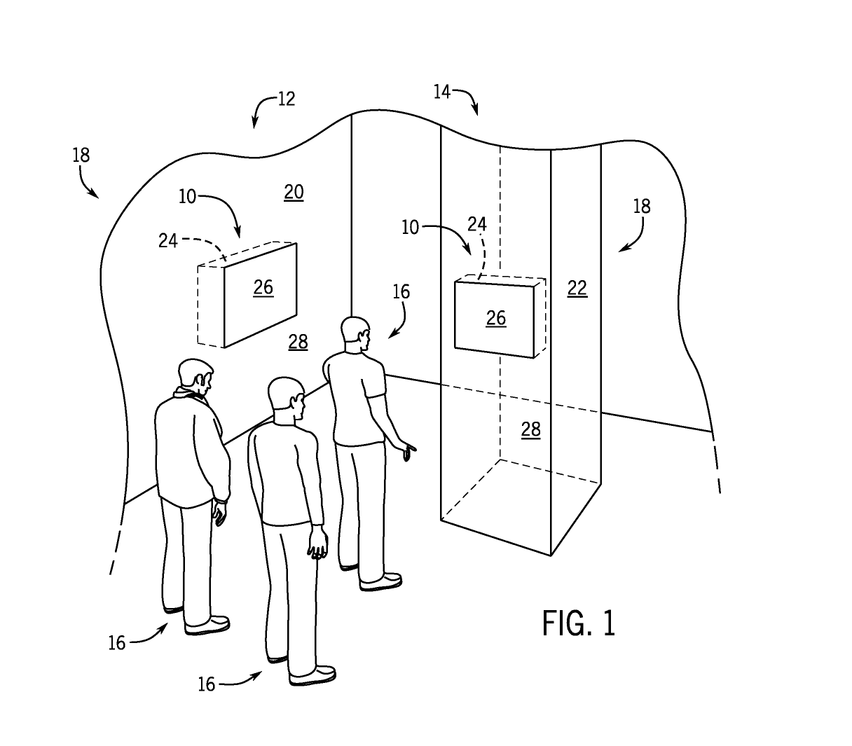

While present embodiments may be implemented in a variety of settings, an example setting in which a dimensional display system 10 is used in an amusement park 12 is shown schematically in FIG. 1. As illustrated, the amusement park 12 includes the dimensional display system 10 in a viewing area 14 (e.g., a room, a themed space or environment). As will be discussed below, the dimensional display system 10 is configured to display a holographic-like presentation (e.g., video, text, image, motion graphics, or a combination thereof) with visual depth cues (e.g., parallax and perspective) to one or more audiences 16 in the viewing area 14. The dimensional display system 10 may be integrated with or embedded in a display arrangement 18, such as a wall 20, a pillar 22, or any other suitable arrangement. For example, the dimensional display system 10 fits in a cavity 24 in the display arrangement 18 and a display area 26 (e.g., display screen) of the dimensional display system 10 is substantially parallel to and flush with an outer surface 28 of the display arrangement 18. In some embodiments, the display area 26 may be off-set (e.g., off-set by a positive or negative distance) from the outer surface 28 of the display arrangement 18. The one or more audiences 16 viewing the display area 26 may perceive a holographic-like presentation for realistic and/or immersive viewing experiences.

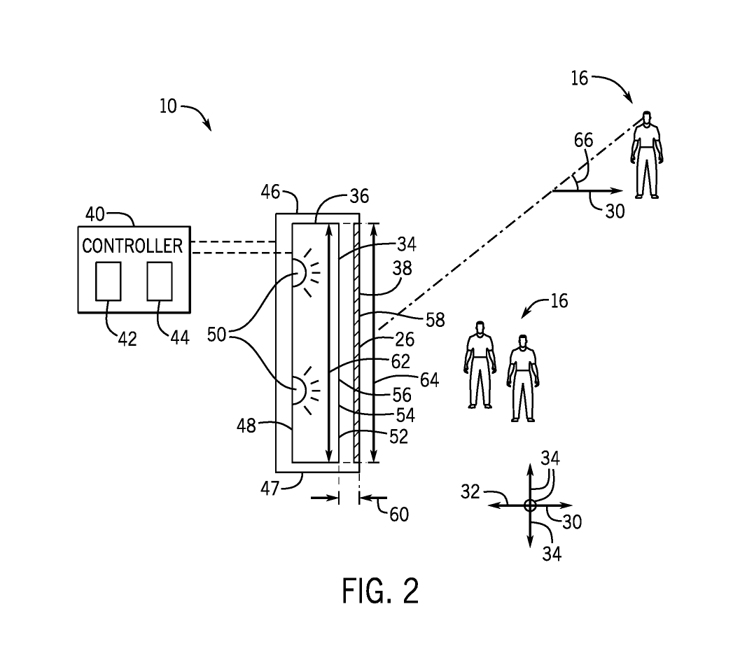

FIG. 2 is a schematic diagram of a side view of an embodiment of the dimensional display system 10 of FIG. 1. As illustrated, the dimensional display system 10 is depicted with respect to a front direction 30 (e.g., a direction normal to the display area 26), a rear direction 32 opposite to the front direction 30, and side directions 34 orthogonal to the front direction 30 and the rear direction 32. The “holographic-like presentation” may be displayed or presented to the one or more audiences 16 in the front direction 30 and/or the front direction 30 with offsets in the side directions 34. In the illustrated embodiment, the dimensional display system 10 includes a first display device 36, a second display device 38, and a controller 40 operatively coupled to the first and second display devices 36 and 38 (e.g., via wired or wireless connections). The controller 40 has memory circuitry 42 that stores instructions (e.g., software, applications), as well as processing circuitry 44 configured to execute these instructions to control various components of the dimensional display system 10. The dimensional display system 10 includes an enclosure 46 (e.g., a thematic enclosure) configured to enclose or house the entire first display device 36 and to enclose or house all or a portion of the second display device 38. For example, the enclosure 46 is configured to hide or frame edges 47 (e.g., in the side directions 34) of the dimensional display system 10 and to theme the holographic-like presentation to the one or more audiences 16.

The first display device 36 includes a graphic lightbox 48 including one or more light sources 50 disposed in the rear (e.g., the rear direction 32) of the graphic lightbox 48. The graphic lightbox 48 includes a transparent or translucent material 52 configured to be disposed on or integrated with the graphic lightbox 48 at least in a front surface 54 (e.g., a front-facing surface toward the front direction 30) of the graphic lightbox 48. A first graphic image 56 may be disposed on the transparent or translucent material 52 via any suitable methods (e.g., painted-on, printed-on, laminated-with, integrated-with) such that the transparent or translucent material 52 is substantially or entirely covered by the first graphic image 56. Material defining the first graphic image 56 may include various characteristics (e.g., opaque, translucent, light filtering, or a combination thereof). The one or more light sources 50 may operate to substantially evenly illuminate the first graphic image 56. As the light generated by the one or more light sources 50 shines through the rear side (e.g., the rear direction 32) of the transparent or translucent material 52, the entire first graphic image 56 is substantially evenly illuminated, creating a glowing “graphic light box.” For example, the first graphic image 56 may appear to be glowing when viewed from the front direction 30, the side directions 34, or a combination thereof. In some embodiments, the first display device 36 may be replaced with a liquid crystal display (LCD) or the like, instead of the graphic lightbox 48, to display the first graphic image 56. The second display device 38 includes a transparent LCD display or any other suitable transparent display to display a second graphic image 58. The second display device 38 may be backlit by the one or more light sources 50 or lit using side-lighting features (e.g., integral light sources of a transparent LCD display).

Furthermore, the first display device 36 and the second display device 38 are configured such that the first graphic image 56 and the second graphic image 58 together form a composite image that is perceived by the one or more audiences 16 as holographic-like. In particular, the second graphic image 58 is formatted to compliment and/or to accentuate the first graphic image 56 with a 3-dimensional (3D) effect or a visual depth cue (e.g., parallax and perspective), or vice versa (e.g., the first graphic image 56 is formatted to compliment and/or accentuate the second graphic image 58). As illustrated, the first display device 36 and the second display device 38 are arranged substantially parallel to one another and spaced apart from one another with a distance or gap 60, such that the combination of the first graphic image 56 and the second graphic image 58 creates an illusion of holographic presentation (e.g., the holographic-like presentation in the form of video, text, image, motion graphics, or a combination thereof) standing off from the designated area of the dimensional display system 10. For example, the first graphic image 56 glows out of the first display device 36 and the glow substantially overlaps with the second graphic image 58, such that the combination of the first and second graphic images 56 and 58 together form the holographic-like presentation (e.g., the first and second graphic images 56 and 58 collectively form the holographic-like presentation). As may be appreciated, the designated area may be in front of the dimensional display system 10 or to the sides of the dimensional display system 10 (e.g., the front direction 30 or the front direction 30 with components of the side directions 34).

In some embodiments, the distance or gap 60 may be about 0.6 centimeters (cm) to about 5.0 cm, about 1 cm to about 4 cm, about 2 cm to about 3 cm, or combined ranges. In some embodiments, the distance or gap 60 may be any suitable values depending on display sizes of the first and second display devices 36 and 38. For example, the first display device 36 has a display size 62 (e.g., the diagonal length of the transparent or translucent material 52) and the second display device 38 has a display size 64 (e.g., the diagonal length of a LCD display screen). The display sizes 62 and 64 may be the same size or may be different sizes. The distance or gap 60 may increase or decrease depending on the display size 62, the display size 64, a ratio between the display sizes 62 and 64 (which may represent diagonal measures), or a combination thereof. In one embodiment, the ratio of distance or gap 60 to display size (e.g., display size 62 or display size 64 or some combination of the measure) may be in the range of about 1:100 to about 5:100. The distance or gap 60 may be changed or adjusted (e.g., increased or decreased) to improve the combined visual effects of the first and second graphic images 56 and 58 to accentuate the 3D effect or visual depth of the holographic-like presentation.

In some embodiments, the first graphic image 56 may be static or have a fixed format to align with one or more portions of the second graphic image 58 to accentuate the 3D effect or visual depth of the holographic-like presentation. In some embodiments, both the first and second graphic images 56 and 58 may be dynamic (e.g., the first display device 36 may be replaced with a LCD or the like, instead of the graphic lightbox 48, to display a static or dynamic image). In some embodiments, both the first and second graphic images 56 and 58 may be static or fixed images. In some embodiments, the first graphic image 56 may be a static or fixed image and the second graphic image 58 may be a dynamic image, or vice versa. In some embodiments, at least one of the first and second graphic images 56 and 58 may be a negative image (e.g., light passes through areas that substantially define the image while light is blocked in other areas).

The controller 40 is configured to regulate operation and/or display contents (e.g., the first and second graphic images 56 and 58) of the first and second display devices 36 and 38. In some embodiments, the controller 40 (e.g., a DMX light controller) may control lighting effects of the first and second display devices 36 and 38 to improve the combined visual effects of the first and second graphic images 56 and 58 and to accentuate the 3D effect or visual depth of the holographic-like presentation. The lighting effects may include light distribution, light gradient, light intensity, etc.

It should be noted that at least partially due to the specific configurations of the components of the dimensional display system 10, the 3D effect or visual depth may be more accentuated toward the sides (e.g., in the side directions 34) of the dimensional display system 10 than toward the front (e.g., the front direction 30). For example, the one or more audiences 16 may perceive the holographic-like presentation with more intense visual depth if the one or more audiences 16 are viewing the media content from a viewing angle 66 (e.g., with respect to the front direction 30 or the normal direction of the second display device 38). As the viewing angle 66 gets greater, the 3D effect or visual depth perceived by the one or more audiences 16 is further accentuated or intensified.

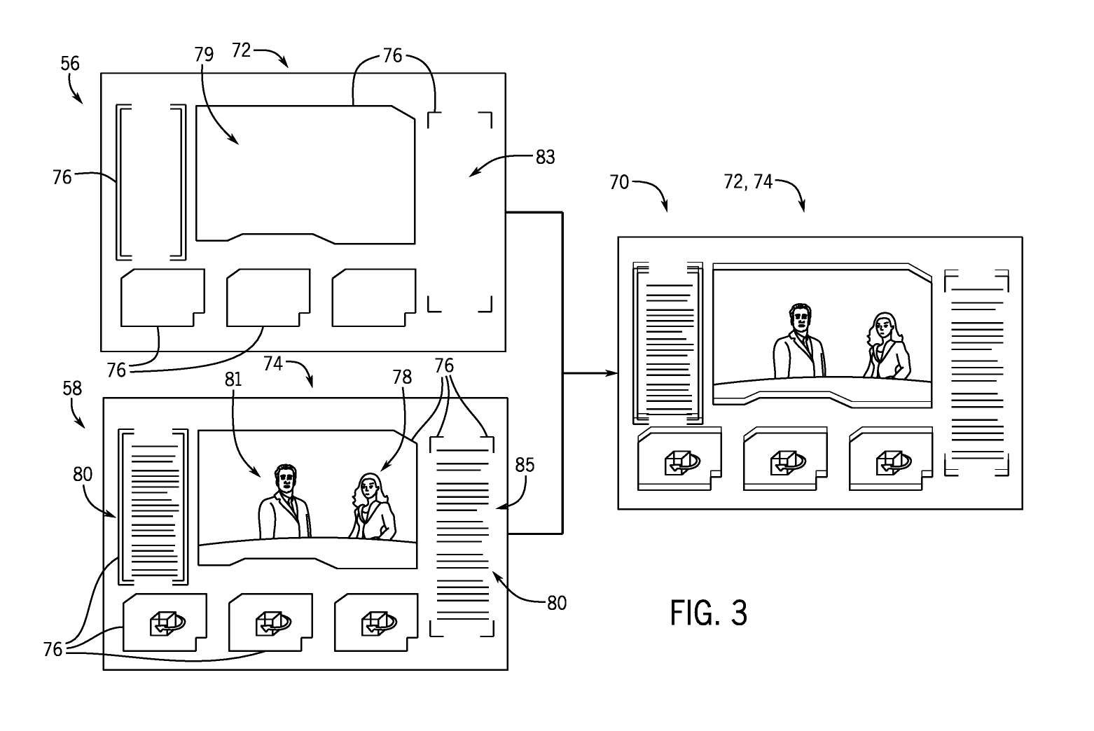

By way of non-limiting example, FIG. 3 is a schematic illustrating a holographic-like presentation 70 produced by the dimensional display system 10 of FIG. 1 based on the combination of the first graphic image 56 and the second graphic image 58. In the illustrated embodiment, the first graphic image 56 includes a first portion 72 of the holographic-like presentation 70 and the second graphic image 58 includes a second portion 74 of the holographic-like presentation 70. The second portion 74 may include detailed features and the first portion 72 may include frames that surround, align, or accentuate the detailed features. The holographic-like presentation 70 includes both the first portion 72 and the second portion 74 that are displayed at a distance apart (e.g., the distance or gap 60 in FIG. 2), such that a 3D effect or a visual depth cue (e.g., parallax and perspective) is perceived by the one or more audiences 16 (FIG. 1).

In some embodiments, the first graphic image 56 and the second graphic image 58 may be coordinated with similar or matching static or fixed features to facilitate the mimicking of a hologram for an observer in the holographic-like presentation 70. For example, both the first and second graphic images 56 and 58 may include background frames 76 (e.g., the background frames 76 in the second graphic image 58 has a corollary or a corresponding copy of representation in the first graphic image 56) such that the second graphic image 58 appears to be hovering beyond the background frames 76 to an observer in the holographic-like presentation 70.

In some embodiments, while portions of the second graphic image 58 may display significant movement, other portions of the second graphic image 58 may remain substantially static or fixed. For example, in the illustrated embodiment, the second graphic image 58 may include dynamic portions (e.g., video or motion-based characteristics) indicated by an arrow 78 and static portions (e.g., text representing menus or border areas with background imagery) indicated by arrows 80. The dynamic portions indicated by the arrow 78, the static portions indicated by the arrows 80, or both may be coordinated with similar or matching features of the first graphic image 56 (e.g., a static image) to facilitate the mimicking of a hologram for an observer in the holographic-like presentation 70. In some cases, only the static portions (e.g., indicated by the arrows 80) of the second graphic image 58 has a corollary or a corresponding copy of representation in the first graphic image 56. In some cases, the dynamic portions (e.g., indicated by the arrow 78) of the second graphic image 58 may also have a corollary or a corresponding copy of representation in the first graphic image 56.

In some embodiments, lighting effects (e.g., light distribution, light gradient, light intensity) for the first graphic image 56 may be adjusted by the controller 40 to emphasize aspects of the first graphic image 56 in conjunction with some portions of the second graphic image 58. For example, an area (e.g., indicated by an arrow 79) of the first graphic image 56 depicting a character may be highly backlit when a corresponding representation of the character (e.g., indicated by an arrow 81) is being shown in the second graphic image 58 in a corresponding location. For example, an area (e.g., indicated by an arrow 83) of the first graphic image 56 depicting texts may be highly backlit when a corresponding representation of the texts (e.g., indicated by an arrow 85) is being shown in the second graphic image 58 in a corresponding location.

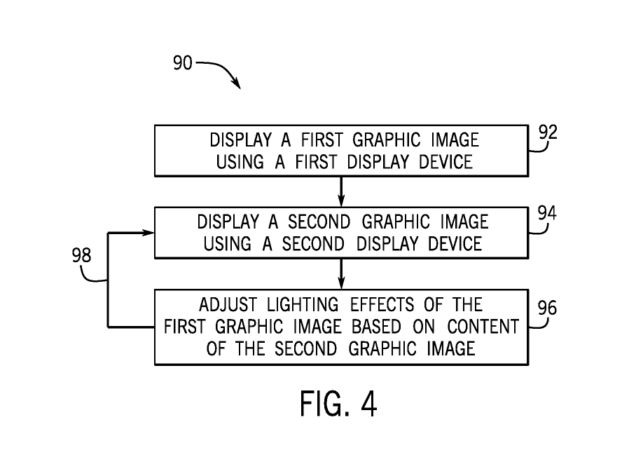

FIG. 4 is a flow chart of an embodiment of a method 90 for producing a holographic-like presentation using the dimensional display system 10. One or more of the steps of the method 90 may be executed by the controller 40. Referring to the dimensional display system 10 of FIGS. 1 and 2, the method 90 may include displaying (step 92) a first graphic image 56 using the first display device 36. For example, the controller 40 may instruct the one or more light sources 50 of the graphic lightbox 48 to substantially evenly illuminate the first graphic image 56. For example, in cases that the first display device 36 includes a LCD or the like, instead of the graphic lightbox 48, the controller 40 may instruct the LCD or the like to display the first graphic image 56. The method 90 may include displaying (step 94) a second graphic image 58 using the second display device 38. For example, the controller 40 may instruct the second display device 38 to display the second graphic image 58. The controller 40 may instruct the second display device 38 to display the second graphic image 58 prior to, after, or simultaneous to step 92. The method 90 may include adjusting (step 96) lighting of the first graphic image 56 based on content of the second graphic image 58. For example, the controller 40 may instruct the one or more light sources 50 to adjust lighting effects (e.g., light distribution, light gradient, light intensity) of the first graphic image 56 to emphasize aspects of the first graphic image 56 in conjunction with certain features presented in the second graphic image 58. The controller 40 may instruct the one or more light sources 50 to increase or decrease light intensity in a portion of the first graphic image 56 depicting certain features (e.g., character(s), text(s)) when the corresponding representation of the features are shown in the second graphic image 58 in a corresponding location. In some embodiments, the method 90 may repeat the step 96 each time the content of the second graphic image 58 changes as indicated by an arrow 98. This coordination, by the controller 40, of the imagery provided may increase an immersive effect of the mimicked holographic image.

While only certain features of the disclosure have been illustrated and described herein, many modifications and changes will occur to those skilled in the art. It is, therefore, to be understood that the appended claims are intended to cover all such modifications and changes as fall within the true spirit of the present disclosure. The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A media display system, comprising:
a first display device configured to display a first graphic image; and
a second display device comprising a transparent display configured to display a second graphic image, wherein the first display device and the second display device are spaced apart from one another at a distance, such that the first graphic image overlaps with the second graphic image to collectively form a holographic-like presentation.

2. The media display system of claim 1, wherein the transparent display comprises a transparent liquid crystal display.

3. The media display system of claim 2, wherein the first display device comprises a graphic lightbox.

4. The media display system of claim 3, wherein the graphic lightbox comprises a transparent material and the first graphic image is painted-on, printed-on, laminated-with, or integrated-with the transparent material.

5. The media display system of claim 1, wherein the first display device comprises a liquid crystal display.

6. The media display system of claim 1, wherein the distance correlates to a ratio between the first display size and the second display size.

7. The media display system of claim 1, wherein the distance is about 0.6 centimeters (cm) to about 5.0 cm, about 1 cm to about 4 cm, or about 2 cm to about 3 cm.

8. The media display system of claim 1, comprising a housing configured to enclose an entire portion of the first display device and at least a portion of the second display device.

9. The media display system of claim 1, comprising a controller configured to coordinate operation of the first display device and the second display device.

10. A method of forming a holographic-like presentation, comprising:
displaying a first graphic image using a first display device, such that the first graphic image appears to glow out of the first display device; and
displaying a second graphic image using a second display device, wherein the second display device comprises a transparent display disposed at a distance apart from the first display device, such that the first graphic image overlaps with the second graphic image and collectively form the holographic-like presentation.

11. The method of claim 10, wherein displaying the first graphic image comprises instructing one or more light sources to illuminate the first graphic image that is painted-on, printed-on, laminated-with, or integrated-with a transparent material of the first display device.

12. The method of claim 10, wherein displaying the first graphic image comprises instructing a liquid crystal display of the first display device to display a static image or a dynamic image.

13. The method of claim 10, wherein displaying the second graphic image comprises instructing a transparent liquid crystal display of the second display device to display a static image or a dynamic image.

14. The method of claim 10, comprises adjusting lighting effects of the first graphic image based on content of the second graphic image with a controller.

15. A media display system, comprising:
a first display device comprising a graphic lightbox and configured to display a first graphic image;
a second display device comprising a transparent display and configured to display a second graphic image, wherein the first display device and the second display device are spaced apart from one another at a distance, such that the first graphic image overlaps with the second graphic image to collectively form a holographic-like presentation; and
a controller operatively coupled to the first display device and the second display device.

16. The media display system of claim 15, wherein the graphic lightbox comprises a transparent material and the first graphic image is painted-on, printed-on, laminated-with, or integrated-with the transparent material.

17. The media display system of claim 15, wherein the distance corresponds to a ratio between the first display size and the second display size.

18. The media display system of claim 15, wherein the controller is configured to adjust lighting effects of the first graphic device based on content of the second graphic image.

19. The media display system of claim 15, comprising a housing configured to enclose an entirety of the first display device and at least a portion of the second display device.

20. The media display system of claim 19, wherein the housing is configured to fit in a cavity of a wall or a pillar.
